(19) United States
(12) Patent Application Publication
(10) Pub. No.: US 2023/0154633 A1
(43) Pub. Date: May 18, 2023

(54) SYSTEM FOR CONFINING AND COOLING MELT FROM THE CORE OF A NUCLEAR REACTOR

(71) Applicants: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(72) Inventors: ALEKSANDR STALEVICH SIDOROV, Moscow (RU); TATYANA YAROPOLKOVNA DZBANOVSKAYA, Moscow (RU); INNA SERGEEVNA SIDOROVA, Moscow (RU)

(73) Assignees: JOINT-STOCK COMPANY "ATOMENERGOPROEKT", Moscow (RU); SCIENCE AND INNOVATIONS - NUCLEAR INDUSTRY SCIENTIFIC DEVELOPMENT, PRIVATE ENTERPRISE, Moscow (RU)

(21) Appl. No.: 17/619,131

(22) PCT Filed: Dec. 29, 2020
(86) PCT No.: PCT/RU2020/000767

§ 371 Date: Dec. 14, 2021

(30) Foreign Application Priority Data
Mar. 20, 2020 (RU) 2020111695

(51) Int. Cl. G21C 9/016; G21C 15/18

(52) U.S. Cl. CPC G21C 9/016; G21C 15/182

(57) ABSTRACT

The invention relates to the field of nuclear energy, in particular, to systems that ensure the safety of nuclear power plants (NPP), and can be used in severe accidents that lead to reactor pressure vessel and its containment destruction.

The technical result of the claimed invention consists in increasing the reliability of the corium localizing and cooling system of a nuclear reactor, increase of heat removal efficiency from corium of a nuclear reactor.

The technical result is achieved through the use of the membrane and thermal shield installed in the area between the multilayer casing and the cantilever truss in the corium localizing and cooling system of a nuclear reactor.

### TECHNICAL FIELD OF THE INVENTION

The invention relates to the field of nuclear energy, in particular, to systems that ensure the safety of nuclear power plants (NPP), and can be used in severe accidents that lead to reactor pressure vessel and its containment destruction.

The accidents with core meltdown, which may take place during multiple failure of the core cooling system, constitute the greatest radiation hazard.

During such accidents the core melt—corium—by melting the core structures and reactor pressure vessel escapes outside its limits, and the afterheat retained in it may disturb the integrity of the NPP containment—the last barrier in the escape routes of radioactive products to the environment.

To exclude this, it is required to localize the core melt (corium) escaping from the reactor pressure vessel and provide its continuous cooling up to its complete crystallization. The corium localizing and cooling system of a nuclear reactor performs this function, which prevents the damage of the NPP containment and thereby protects the public and environment against exposure effect during severe accidents of nuclear reactors.

### PRIOR ART

The corium localizing and cooling system of a nuclear reactor containing the guide plate installed below the reactor pressure vessel, and resting upon the cantilever truss, installed in the embedded parts in the concrete well foundation of the layered vessel, flange thereof is provided with thermal protection, filler installed inside the layered vessel consisting of a set of cassettes installed in one another.

This system in accordance with its design features has the following disadvantages, namely:
when the reactor vessel is burnt (destructed) by the core melt, the melt starts flowing into the opening formed under the action of residual pressure existing in the reactor vessel, and gases come out, which spread inside the volume of the multilayer casing and inside the peripheral volumes located between the multilayer casing, filler and cantilever truss, there is a rapid increase in gas pressure in these volumes, which may result in the destruction of the corium localizing and cooling system in the place of the multilayer casing connection to the cantilever truss.
when the melt enters the multilayer casing, the cantilever truss and the multilayer casing can move independently relative to each other as a result of heating, impact or seismic effects, which can lead to the destruction of their tight connection and, consequently, the malfunction of the corium localizing and cooling system.

The corium localizing and cooling system [2] of a nuclear reactor containing the guide plate installed under the reactor pressure vessel and resting upon the cantilever truss installed in the embedded parts in the concrete well foundation of the layered vessel, flange thereof is provided with thermal protection, filler installed inside the layered vessel consisting of a set of cassettes installed in one another is known.

This system in accordance with its design features has the following disadvantages, namely:
when the reactor vessel is burnt (destructed) by the core melt, the melt starts flowing into the opening formed under the action of residual pressure existing in the reactor vessel, and gases come out, which spread inside the volume of the multilayer casing and inside the peripheral volumes located between the multilayer casing, filler and cantilever truss, there is a rapid increase in gas pressure in these volumes, which may result in the destruction of the corium localizing and cooling system in the place of the multilayer casing connection to the cantilever truss.
when the melt enters the multilayer casing, the cantilever truss and the multilayer casing can move independently relative to each other as a result of heating, impact or seismic effects, which can lead to the destruction of their tight connection and, consequently, the malfunction of the corium localizing and cooling system.

The corium localizing and cooling system [3] of a nuclear reactor containing the guide plate installed under the reactor pressure vessel and resting upon the cantilever truss installed in the embedded parts in the concrete well foundation of the layered vessel, flange thereof is provided with thermal protection, filler installed inside the layered vessel consisting of a set of cassettes installed in one another, each of them comprises one central and several peripheral holes, water supply valves, installed in the branch pipes located along the perimeter of the layered vessel in the area between the upper cassette and flange is known.

This system in accordance with its design features has the following disadvantages, namely:
when the reactor vessel is burnt (destructed) by the core melt, the melt starts flowing into the opening formed under the action of residual pressure existing in the reactor vessel, and gases come out, which spread inside the volume of the multilayer casing and inside the peripheral volumes located between the multilayer casing, filler and cantilever truss, there is a rapid increase in gas pressure in these volumes, which may result in the destruction of the corium localizing and cooling system in the place of the multilayer casing connection to the cantilever truss.
when the melt enters the multilayer casing, the cantilever truss and the multilayer casing can move independently relative to each other as a result of heating, impact or seismic effects, which can lead to the destruction of their tight connection and, consequently, the malfunction of the corium localizing and cooling system.

### DISCLOSURE OF THE INVENTION

The technical result of the claimed invention consists in increasing the reliability of the corium localizing and cooling system of a nuclear reactor, increase of heat removal efficiency from corium of a nuclear reactor.

The tasks for resolving thereof the claimed invention is directed are the following:
ensuring that the multilayer casing is sealed against flooding by water coming in to cool the outer surface of the multilayer casing;
ensuring independent radial-azimuthal thermal expansions of the cantilever truss;
ensuring independent movements of the cantilever truss and the multilayer casing during seismic and shock mechanical impacts on the components of the corium localizing and cooling system's equipment;
ensuring the necessary hydraulic resistance during the movement of the vapor-gas mixture from the internal volume of the reactor pressure vessel to the space located in the area of the tight connection between the multilayer casing and the cantilever truss.

The tasks set are solved by the fact that the corium localizing and cooling system of a nuclear reactor containing a guide plate installed under the nuclear reactor pressure vessel, and supported on a cantilever truss, a multilayer casing mounted on embedded parts in the base of the concrete cavity designed to receive and distribute the melt, whose flange is provided with thermal shield, filler consisting of several cartridges installed on top of each other, each containing one central and several peripheral openings, water supply valves installed in the branch pipes located along the perimeter of the multilayer casing in the area between the upper cartridge and the flange, according to the invention also contains convex membrane installed between the flange of the multilayer casing and the bottom surface of the cantilever truss so that the convex side faces outside the multilayer housing, at the same time, thermal resistance elements are made in the upper part of the convex membrane in the zone of connection with the lower part of the cantilever truss, connected to each other by welding to form a contact gap, a thermal shield is additionally installed inside the multilayer casing, containing outer, inner shells and the head, mounted to the cantilever truss by thermally destructed fasteners installed in the heat conducting flange of thermal shield, and overlapping the upper part of the thermal shield flange of multilayer casing, between them a circular coffer with openings is installed in the overlapping area, and the outer shell is made in such a way that its strength is higher than the strength of the inner shell and the head, and a layer of fusible concrete is applied on the outer shell, divided into sectors by vertical ribs and held by vertical, long radial and short radial reinforcement bars.

One of the essential features of the claimed invention is a convex membrane available in the corium localizing and cooling system of a nuclear reactor installed between the flange of the multilayer casing and the lower surface of the cantilever truss so that the convex side faces outside the multilayer casing, with thermal resistance elements in the upper part of the convex membrane in the zone of connection with the lower part of the cantilever truss, connected to each other by welding to form contact gap. This design allows the multilayer casing to be sealed against flooding by water coming in to cool the outer surface of the multilayer casing, to provide independent radial-azimuthal thermal expansion of the cantilever truss, to provide axial-radial thermal expansion of the multilayer casing, to provide independent movement of the cantilever truss and multilayer casing during seismic and shock mechanical impacts on the components of the corium localizing and cooling system.

Another essential feature of the claimed invention is a thermal shield available in the corium localizing and cooling system of a nuclear reactor, which is mounted to the cantilever truss and overlaps the upper part of the thermal shield of the multilayer casing flange to form a slot gap that prevents a direct impact from the core melt and from the gas dynamic flows from the reactor pressure vessel to the area of the tight connection of the multilayer casing with the cantilever truss.

Another essential feature of the claimed invention is that a circular coffer with holes is installed in the corium localizing and cooling system of a nuclear reactor in the zone of overlapping of the thermal shield and the thermal shield of the multilayer casing flange, which covers the slot gap between the thermal shield of the casing flange and the thermal shield. Due to its functionality, the circular coffer with holes forms a kind of velocity seal, which provides the necessary hydraulic resistance when the steam-gas mixture moves from the internal volume of the reactor pressure vessel to the space located behind the outer surface of the thermal shield, and reduces the pressure growth rate at the periphery, while increasing the time of this pressure growth, which provides the necessary time for the pressure equalization inside and outside the multilayer casing.

### BRIEF DESCRIPTION OF DRAWINGS

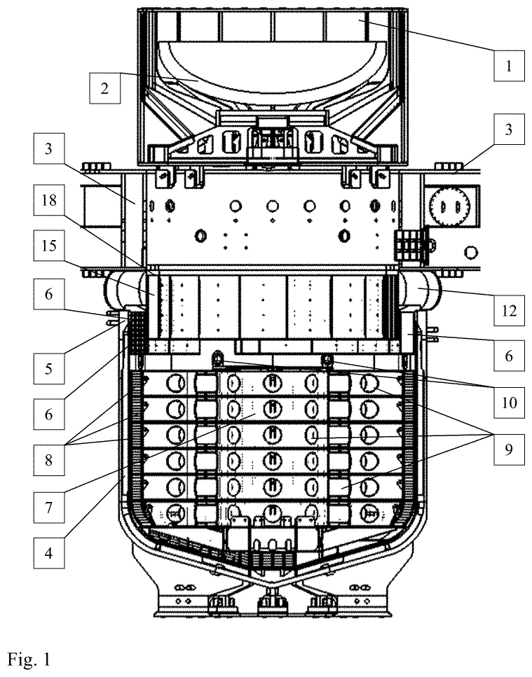

The corium localizing and cooling system of a nuclear reactor executed in accordance with the claimed invention is show in FIG. 1.

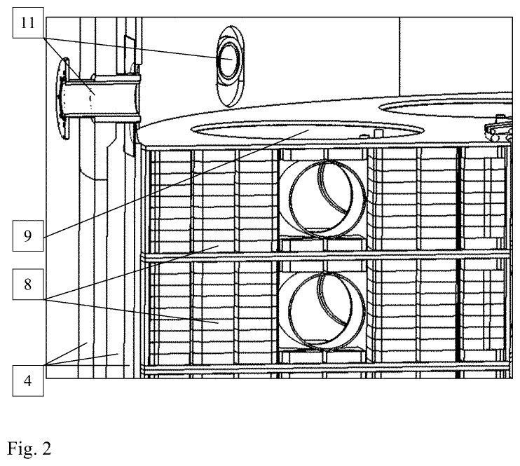

The area between the filler upper cassette and lower surface of the cantilever truss is shown in FIG. 2.

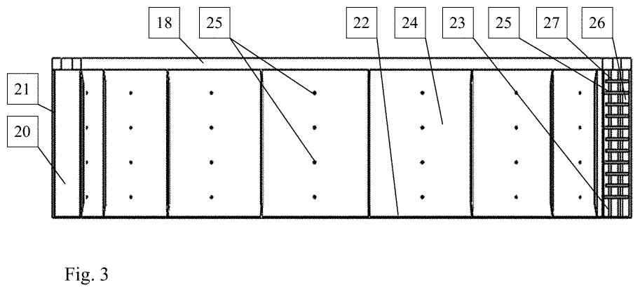

The general view of the thermal protection executed in accordance with the claimed invention is shown in FIG. 3.

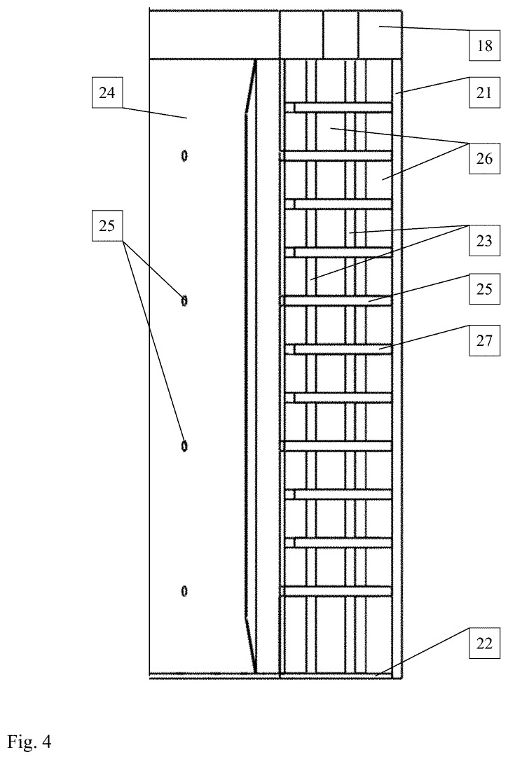

The fragment of thermal protection in section executed in accordance with the claimed invention is shown in FIG. 4.

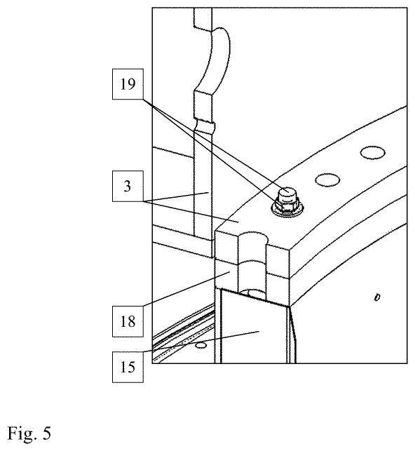

The securing area of the thermal protection to the cantilever truss is shown in FIG. 5.

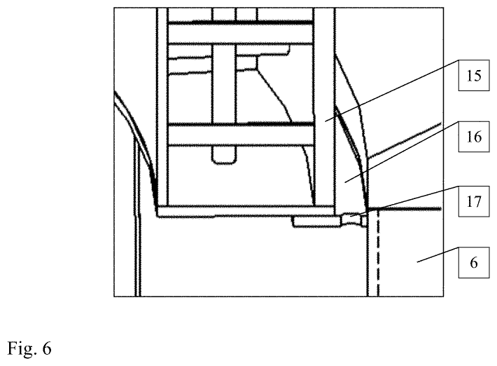

The circular coffer executed in accordance with the claimed invention is shown in FIG. 6.

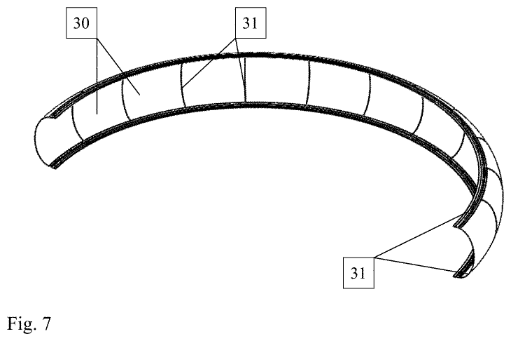

The general view of the membrane, executed in accordance with the claimed invention is shown in FIG. 7.

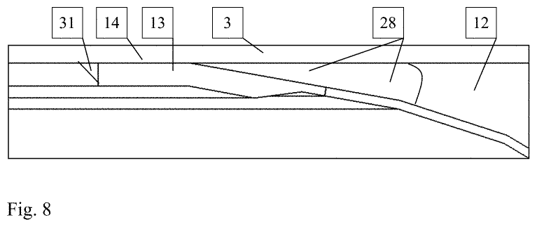

The joining area of the membrane with the lower surface of the cantilever truss is shown in FIG. 8.

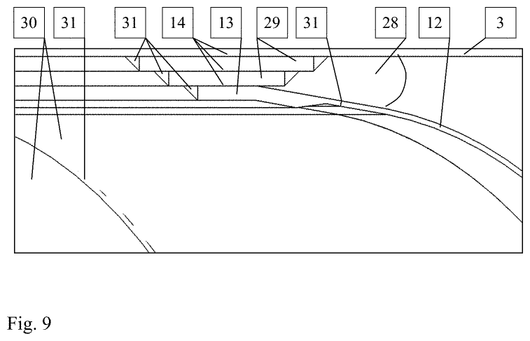

The joining area of the membrance with the lower surface of the cantilever truss executed using additional plates is shown in FIG. 9.

### EMBODIMENT OF THE INVENTION

As shown in FIGS. 1-9, a corium localizing and cooling system of a nuclear reactor comprising a guide plate (1) mounted under the nuclear reactor pressure vessel (2). The guide plate (1) rests on the cantilever truss (3). Under the cantilever truss (3) at the base of the concrete cavity, there is a multi-layer casing (4) mounted on embedded parts and designed to receive and distribute the melt. The flange (5) of the multilayer casing (4) is provided with thermal shield (6). There is a filler (7) inside the multilayer casing (4). The filler (7) consists of several cartridges (8) mounted on top of each other. Each cartridge (8) has one central and several peripheral holes (9). Water supply valves (10) installed in branch pipes (11) are located along the perimeter of the multilayer casing (4) in its upper part (in the area between the upper cartridge (8) and the flange (5)). A convex membrane (12) is located between the flange (5) of the multilayer casing (4) and the lower surface of the cantilever truss (3). The convex side of the membrane (12) faces outside the multilayer casing (4). Thermal resistance elements (13) are made in the upper part of the convex membrane (12) in the area of connection with the lower part of the cantilever truss (3). The elements (13) of thermal connection are connected to each other by welding to form a contact gap (14). There is a thermal shield (15) inside the multilayer casing (4). The thermal shield (15) consists of outer (21), inner (24) shells and a head (22). The thermal shield (15) is mounted to the cantilever truss (3) by means of thermally destructed fasteners (19), which are installed in the thermally conductive flange (18) of the thermal shield (15). The thermal shield (15) is mounted so that it overlaps the upper part of the thermal shield (6) of the flange (5) of the multilayer casing (4), between which a circular coffer (16) with holes (17) is installed in the overlapping area. The outer shell (21) is executed in such manner that its strength is above the strength of the inner shell (24) and head (22). The space between the outer shell (21), head (22) and inner shell (24) is filled with melting concrete (26). The fusible concrete (26) is held (bound) by vertical (23), long radial (25) and short radial (27) reinforcing bars.

The claimed corium localizing and cooling system of a nuclear reactor according to the claimed invention operates as follows.

When the nuclear reactor pressure vessel (2) fails, the core melt, exposed to hydrostatic pressure of the melt and residual gage pressure of gas inside the nuclear reactor pressure vessel (2), starts flowing to the surface of the guide plate (1) held by the cantilever truss (3). The melt, flowing down the guide plate (1), enters the multilayer casing (4) and comes into contact with the filler (7). In case of sectoral nonaxisymmetric melt flow, thermal shield melts (15). By partially destroying, the thermal shield (15), on the one hand, reduces the thermal impact of the core melt on the protected equipment, and on the other hand, reduces the temperature and chemical activity of the melt itself.

Thermal shield (6) of the flange (5) of the multilayer casing (4) protects its upper thick-walled inner part against thermal influence from the core melt plane from the moment of melt ingress into the filler (7) until the melt interaction with the filler is completed, i.e. until the water starts cooling the crust on the core melt surface. The thermal shield (6) of the flange (5) of the multilayer casing (4) is installed so as to protect the inner surface of the multilayer casing (4) above the level of the core melt formed in the multilayer casing (4) during interaction with the filler (7), namely the upper part of the multilayer casing (4), which is thicker than the cylindrical part of the multilayer casing (4) that ensures normal (without heat exchange crisis in pool boiling mode) heat transfer from the core melt to the water located on the outer side of the multilayer casing (4).

During interaction between the core melt and the filler (7), the thermal shield (6) of the flange (5) of the multilayer casing (4) is heated and partially destroyed, shielding the thermal radiation from the melt plane. Geometrical and thermophysical characteristics of the thermal shield (6) of the flange (5) of the multilayer casing (4) are chosen so as to ensure its shielding from the melt plane under all conditions, which in turn ensures that the protective functions are independent of the completion of physical and chemical interaction of the core melt with the filler (7). Thus, the presence of thermal shield (6) of the flange (5) of the multilayer casing (4) ensures performance of protective functions before the start of water supply to the crust on the surface of the core melt.

The thermal shield (15), as shown in FIGS. 1 and 3, attached to the cantilever truss (3) above the upper level of the thermal shield (6) of the flange (5) of the multilayer casing (4), with its lower part covers the upper part of the thermal shield (6) of the flange (5) of the multilayer casing (4), providing protection against the effects of thermal radiation from the core melt plane not only for the lower part of the cantilever truss (3), but also for the upper part of the thermal shield (6) of the flange (5) of the multilayer casing (4). The geometric characteristics such as the distance between the outer surface of the thermal shield (15) and the inner surface of the thermal shield (6) of the flange (5) of the multilayer casing (4), and the overlapping height of the said thermal shields (15 and 6) have been chosen so that the gap formed as a result of such overlap, prevented a direct impact effect on the area of the tight connection between the multilayer casing (4) and the cantilever truss (3) both from the moving core melt and from gas-dynamic flows coming out of the reactor pressure vessel (2).

As shown in FIG. 6, the circular coffer (16) with orifices (17) provides overlapping of the slit-type gap between the thermal protection (5) of the flange (5) of the layered vessel (4) and thermal protection (15), and forms a kind of gas dynamic damper that allows provide the required pressure drop during the movement of gas-vapor mixture from the inner space of the reactor pressure vessel (2) to the space located outside the thermal protection (15) surface, and reduce the rate of pressure rise in the periphery, simultaneously increasing the rise time of this pressure that provides the required time for levelling pressure inside and outside the layered vessel (4). The steam-gas mixture moves most actively at the moment of destruction of the reactor pressure vessel (2) at the initial stage of core melt outflow. The residual pressure in the reactor pressure vessel (2) affects the gas mixture in the multilayer casing (4), which leads to an increase in pressure also in the periphery of the inner volume of the multilayer casing (4).

FIGS. 4 and 5 show that structurally the thermal shield (15) consists of a flange (18) connected to the cantilever truss flange (3) by means of thermally destructed fasteners (19), an outer shell (21), an inner shell (24), a head (22) and vertical ribs (20). The space between the outer shell (21), head (22) and inner shell (24) is filled with melting concrete (26). Fusible concrete (26) provides absorption of thermal radiation from the melt plane over the entire range of its heating and phase transformation from a solid state to a liquid. In addition, the thermal shield (15) includes vertical reinforcing bars (23), long radial reinforcing bars (25), and short radial reinforcing bars (27) that reinforce the fusible concrete (26).

FIGS. 1 and 7 show that a convex membrane (12) installed between the flange (5) of the multilayer casing (4) and the bottom surface of the cantilever truss (3) in the space behind the outer surface of the thermal shield (15) provides sealing to the multilayer casing (4) against flooding by water coming in to cool its outer surface.

The membrane (12) provides independent radial and azimuthal thermal expansions of the cantilever truss (3) and axial and radial thermal expansions of the layered vessel (4), provided independent displacements of the cantilever truss 93) and layered vessel (4) during earthquake and impact mechanical actions on the equipment elements of the corium localizing and cooling system of a nuclear reactor.

In order that the membrane (12) can preserve its function during the initial stage of the core melt flow from the reactor pressure vessel (2) into the multilayer casing (4) and the associated pressure increase, the membrane (12) is placed in the protected space formed by the thermal shield (6) of the flange (5) of the multilayer casing (4) and the thermal shield (15) attached to the cantilever truss (3).

After the cooling water starts flowing inside the multilayer casing (4) onto the crust on the melt surface, the membrane (12) keeps performing its functions of sealing the internal volume of the multilayer casing (4) and separating the internal and external media. In the mode of steady water cooling of the outer surface of the multilayer casing (4), the membrane (12) is not destroyed, being cooled by water from the outside.

In case of loss of the cooling water supply inside the multilayer housing (4) on the crust, the thermal shield (6) of the flange (5) of the multilayer casing (4) and the thermal shield (15) gradually collapse, the overlap area of thermal shield (15 and 6) gradually decreases until the total failure of the overlap area. At this point, the impact of thermal radiation on the membrane (12) from the core melt plane begins. The membrane (12) starts heating from the inside, but due to its small thickness, the radiant heat flux cannot ensure the membrane's (12) failure, if the membrane (12) is below the cooling water level.

FIGS. 8 and 9 show that to ensure the membrane (12) failure under conditions of loss of the cooling water supply from above to the core melt crust, the membrane (12) is connected to the bottom surface of the cantilever truss (3) by thermal resistance elements (13) connected to each other by welding to form a contact gap (14). In the junction area of the membrane (12) and the lower surface of the cantilever truss (3), a pocket (28) is formed along the upper perimeter, which provides deteriorated heat transfer conditions from the membrane (12) to the water, which, in the presence of thermal shield (15) and thermal shield (6) of the flange (5) of the multilayer casing (4) that close the membrane (12) from thermal radiation from the melt plane, provide cooling of the membrane (12), but these conditions of deteriorated heat exchange cannot provide an effective heat removal in case of strong heating with radiant heat flows from the melt plane when the thermal shields (15 and 6) fail.

The structural location of the pocket (28) (position of the junction of the membrane (12) with the cantilever truss (3) in radial and axial directions) relative to the position of the melt plane level depends on the position of the maximum level of water coming for cooling the outer surface of the multilayer casing (4), the higher this level is, the further the pocket (28) is from the position of the melt plane level (from the thermal emission plane).

As the thermal shield (15) fails, radiant heat fluxes from the melt plane starts affecting intensively the equipment located below the pocket position (28). In the absence of cooling of the melt plane, it is necessary to reduce overheating and destruction of equipment located below the position of the pocket (28); to achieve this, the junction of the membrane (12) and the cantilever truss (3) is facing the melt plane and is directly heated by radiant heat flows, and the pocket (28) is designed with elements (13) of thermal resistance, which reduce the heat transfer from the junction of the membrane (12) and the cantilever truss (3). For this purpose, additional plates (29) are installed between the membrane (12) and the cantilever truss (3), as shown in FIG. 9, which are welded to each other and to the cantilever truss (3) only along the perimeter. The membrane (12) welded to the additional plate (29) cannot transfer heat over a large area due to the fact that there are contact gaps (14) both between the membrane (12) and the additional plate (29), between the additional plates (29) themselves, and between the additional plate (29) and the cantilever truss (3), that provide thermal resistance to heat transfer into the thick-walled cantilever truss (3) (the cantilever truss is thick-walled in relation to the membrane—in its ability to accumulate and redistribute the heat received). The use of thermal resistance elements (13) reduces the power of radiant heat fluxes to ensure controlled destruction of the membrane (12), and, as a consequence, reduces the temperature inside the multilayer melt (4), while reducing the volume of destruction of thermal shields (15 and 6), reducing the shape changes of the main equipment of the corium localizing and cooling system of a nuclear reactor, providing the necessary safety margin and increasing reliability.

The place of membrane (12) fracture is structurally designed in its upper part, on the border with the lower plane of the cantilever truss (3) in the area formed at the level of the location of the maximum water level around the multilayer casing (4) from the outside, ensuring, when the membrane (12) fractures, the unpressurized flow of cooling water into the inner space of the multilayer casing (4) from above onto the melt crust in the area most closely located to the inner surface of the multilayer casing (4).

If the cooling water level is below the maximum level, the membrane (12) is destroyed by heating and deformation. This process coincides with the destruction of thermal shield (15) and thermal shield (6) of the casing (4) flange (5), the destruction and melting of which reduces the shading of membrane (12) from the radiant heat fluxes from the melt plane, increasing the effective area of the thermal radiation effect on the membrane (12). The process of heating, deformation and destruction of the membrane (12) will develop from top to bottom until the destruction of the membrane (12) leads to the flow of cooling water inside the multilayer casing (4) on the melt crust.

If the cooling water level is located in the area of maximum level location, the membrane (12) is heated as follows: first, heat exchange deteriorates in the pocket (28) and water boiling crisis develops in the pocket (28) with the formation of an overheated steam bubble, which prevents heat removal from the membrane (12), then there is overheating of the upper part of the membrane (12) around the contact gap (14), and then—its deformation and destruction. As a result of the membrane (12) failure, the cooling water starts flowing through the cracks inside the multilayer casing (4) from above onto the melt crust.

Two conditions should be met to ensure the membrane (12) failure from top to bottom: firstly, the heat transfer from the outer surface of the membrane (12) should deteriorate, otherwise the membrane (12) will not collapse; secondly, it is necessary to have vertically located inhomogeneities, which ensure the formation of cracks. The first condition is achieved by using a convex membrane (12), for example, semicircular, facing towards the cooling water or steam-water mixture, in this case there are two zones of degraded heat exchange: above and below the middle of the membrane (12). The use of a concave membrane does not produce this effect—the center of the membrane (12) is in the zone of impaired heat exchange, which does not allow the membrane (12) to heat up the area where the membrane is attached to the cantilever truss (3) until it fails. The second condition is achieved by making the membrane (12) of vertically oriented sectors (30) connected together by welded joints (31), as shown in FIG. 7, which provide vertical inhomogeneities periodically arranged around the perimeter of the membrane (12) that contribute to vertical failure. The geometrical characteristics of the membrane (12), together with the properties of the basic and welding materials used in the manufacture, allow the directional vertical destruction of the membrane (12) when exposed to radiant heat fluxes from the melt plane. As a result, the membrane (12) not only seals the inner volume of the multilayer casing (4) against uncontrolled ingress of water cooling the outer surface of the multilayer casing (4) during normal (regular) water supply to the melt surface, but also protects the multilayer casing (4) against overheating if the cooling water supply to the interior of the multilayer casing (4) fails.

Thus, the use of the membrane (12) as part of the corium localizing and cooling system of a nuclear reactor provides sealing of the multilayer casing against flooding with water supplied to cool the outer surface of the multilayer casing, independent radial-azimuthal thermal expansion of the cantilever truss, independent movement of the cantilever truss and multilayer casing during seismic and shock mechanical impacts on the components of the melt confinement and cooling system equipment, and the use of thermal shield (15) provides the necessary hydraulic resistance when the steam-gas mixture moves from the internal volume of the reactor pressure vessel to the space located in the area of the tight connection between the multilayer casing and the cantilever truss, which, taken together, increases the reliability of the system as a whole.

Sources of information:
1. RF patent No. 2576517, IPC G21C 9/016, priority on 16.12.2014;
2. RF patent No. 2576516, IPC G21C 9/016, priority on 16.12.2014;
3. RF patent No. 2696612, IPC G21C 9/016, priority on 26.12.2018.

1. A corium localizing and cooling system of a nuclear reactor containing a guide plate (1) mounted under the nuclear reactor pressure vessel (2) and supported on a cantilever truss (3), a multilayer casing (4) mounted on embedded parts in the base of the concrete cavity, designed to receive and distribute the melt, (5) a flange (5) with thermal shield (6), a filler (7) consisting of several stacked cartridges (8), each having one central and several peripheral openings (9), and water supply valves (10) mounted in branch pipes (11) located along the perimeter of the multilayer casing (4) in the area between the upper cartridge (8) and the flange (5), characterized in that it additionally contains a convex membrane (12) consisting of vertically oriented sectors (30) connected to each other by welds (31), installed between the flange (5) of the multilayer casing (4) and the bottom surface of the cantilever truss (3) so that the convex side faces outside the multilayer casing (4), whereby the upper part of the convex membrane (12) in the area of connection with the lower part of the cantilever truss (3) has thermal resistance elements (13) connected to each other by welding to form a contact gap (14), the multilayer casing (4) additionally accommodates a thermal shield (15) containing an outer (21), an inner (24) shell and a head (22), attached to the cantilever truss (3) by thermally destructed fasteners (19) installed in the thermally conductive flange (18) of the thermal shield (15) and overlapping the upper part of the thermal shield (6) of the flange (5) of the multilayer casing (4), between which a circular coffer (16) with holes (17) is installed in the overlap area, the outer shell (21) of the thermal shield (15) is designed so that its strength is higher than that of the inner shell (24) and the head (22) and the space between the outer shell (21), the head (22) and the inner shell (24) is filled with fusible concrete (26), divided into sectors by vertical ribs (20) and held by vertical (23), long radial (25) and short radial (27) reinforcement bars.

2. A corium localizing and cooling system of a nuclear reactor according to claim 1 characterized in that additional plates (29) are installed between the convex membrane (12) and the cantilever truss (3) only around the perimeter to each other and to the cantilever truss (3).
